(19) United States
(12) Patent Application Publication
(10) Pub. No.: US 2004/0111007 A1
(43) Pub. Date: Jun. 10, 2004

(54) Isolation chamber

(76) Inventor: Deano Perlatti, Bainbridge Island, WA (US)

Correspondence Address: BLACK LOWE & GRAHAM, PLLC, 701 FIFTH AVENUE, SUITE 4800, SEATTLE, WA, 98104, US

(21) Appl. No.: 10/315,484

(22) Filed: Dec. 9, 2002

(51) Int. Cl. A61G 10/00

(52) U.S. Cl. 600/21

(57) ABSTRACT

An isolation chamber for providing containment for a contaminated patient includes a flexible enclosure that is configurable to receive a contaminated patient therein. The enclosure includes a first side, a second side, a top that is hingedly pivotable about a top of the first side, a bottom, a first end, and a second end. The top is maintained spaced apart from the bottom such that the top is maintained out of physical contact with a contaminated patient received in the enclosure. A plurality of attachment devices are disposed on at least one of the first and second sides or the first and second ends. The plurality of attachment devices are configured to attach to one of the first and second sides or the first and second ends to support members of a stretcher.

### FIELD OF THE INVENTION

The present invention relates generally to containment and, more specifically, to containment of contamination.

### BACKGROUND OF THE INVENTION

Persons who have suffered injuries or trauma are typically transported on a stretcher by Emergency Medical System (EMS) personnel from a scene of an accident or trauma-related event to a hospital for treatment. Some precautions are currently taken to protect against spread of certain conditions from an injured person. For example, EMS personnel and other medical care providers take precautions, such as by wearing latex gloves, to protect themselves against inadvertent spread from the injured person of blood-borne pathogens, such as human immunodeficiency virus (HIV). As is known, blood-borne pathogens are transmitted only through direct contact with the injured person's blood. That is, the blood-borne pathogens do not become airborne.

However, a person in need of transport to a hospital for treatment (hereinafter, a “patient”) may have been contaminated with an airborne agent. For example, the contaminated patient may have been exposed to a nuclear, biological, or chemical (NBC) agent, such as without limitation radioactive contamination, chicken pox virus, smallpox virus, anthrax virus, or chemical reagents such as chlorine products or other toxins. NBC agents become airborne, and therefore can spread contamination readily if they are not contained.

Transporting and treating a contaminated patient presents several issues. For example, EMS personnel initially treat the patient at the scene and enroute to the hospital. Therefore, EMS personnel and a vehicle in which the contaminated patient is transported may become contaminated. Further, the hospital where the contaminated patient is treated, as well as medical care providers who treat the contaminated patient at the hospital, may also become contaminated.

It would be desirable to prevent spread of contamination from a contaminated patient. However, there are not any containment devices for a contaminated patient of which the applicant is aware that are compact, lightweight, and easy to use. Therefore, there is an unmet need in the art for a containment device for a contaminated patient.

### SUMMARY OF THE INVENTION

The present invention provides an isolation chamber that provides containment for a contaminated patient. Advantageously, embodiments of the present invention are usable with different types of stretchers, and are lightweight, easy to use, and storable in a small, compact space. Further, after the isolation chamber has been used to provide containment for a contaminated patient, the isolation chamber may be sterilized for future use or disposed of, as desired.

According to one embodiment of the present invention, an isolation chamber for providing containment for a contaminated patient may be used with a hospital-type stretcher. The isolation chamber includes a flexible enclosure that is configurable to receive a contaminated patient therein. The enclosure includes a first side, a second side, a top that is hingedly pivotable about a top of the first side, a bottom, a first end, and a second end. The top is maintained spaced apart from the bottom such that the top is maintained out of physical contact with a contaminated patient received in the enclosure. A plurality of attachment devices are disposed on at least one of the first and second sides or the first and second ends. The plurality of attachment devices are configured to attach at least one of the first and second sides or the first and second ends to support members of a stretcher.

According to an aspect of the invention, a plurality of enclosures is provided to releasably attach the top to the first and second ends and the second side. The plurality of closures help maintain the top spaced apart from the bottom.

According to another exemplary embodiment of the present invention, an isolation chamber for providing containment for a contaminated patient may be used with a field stretcher. The isolation chamber includes a flexible enclosure that is configurable to receive a contaminated patient therein. The enclosure includes a first end that defines a pocket that extends about a periphery of the first end. The enclosure also includes a second end, a bottom and a top. The top has a first section that is hingedly pivotable about a first side of the bottom and a second section that is hingedly pivotable about a second side of the bottom. A first rod conforms to a shape of the periphery of the first end, and the first rod is receivable in the first pocket. At least one enclosure is disposed on the first and second sections of the top, and the at least one closure is configured to releasably attach the first section of the top to the second section of the top. At least first webbing traverses the bottom between the first and second sides of the bottom.

According to another exemplary embodiment, handles are provided toward the first and second ends, thereby allowing the isolation chamber to be used as a field stretcher.

### BRIEF DESCRIPTION OF THE DRAWINGS

The preferred and alternative embodiments of the present invention are described in detail below with reference to the following drawings.

FIG. 1 is a perspective view of one embodiment of an exemplary isolation chamber of the present invention;

FIG. 2 is a perspective view of the isolation chamber of FIG. 1 in use on an exemplary stretcher;

FIG. 3 is a perspective view of an alternate embodiment of an exemplary isolation chamber of the present invention; and

FIG. 4 is a perspective view of a variant of the isolation chamber of FIG. 3.

### DETAILED DESCRIPTION OF THE INVENTION

By way of overview, the present invention provides an isolation chamber that provides containment for a contaminated patient. Advantageously, embodiments of the present invention are usable with different types of stretchers and are lightweight, easy to use, and storable in a small, compact space. Further, after the isolation chamber has been used to provide containment for a contaminated patient, the isolation chamber may be sterilized for future use or disposed of, as desired.

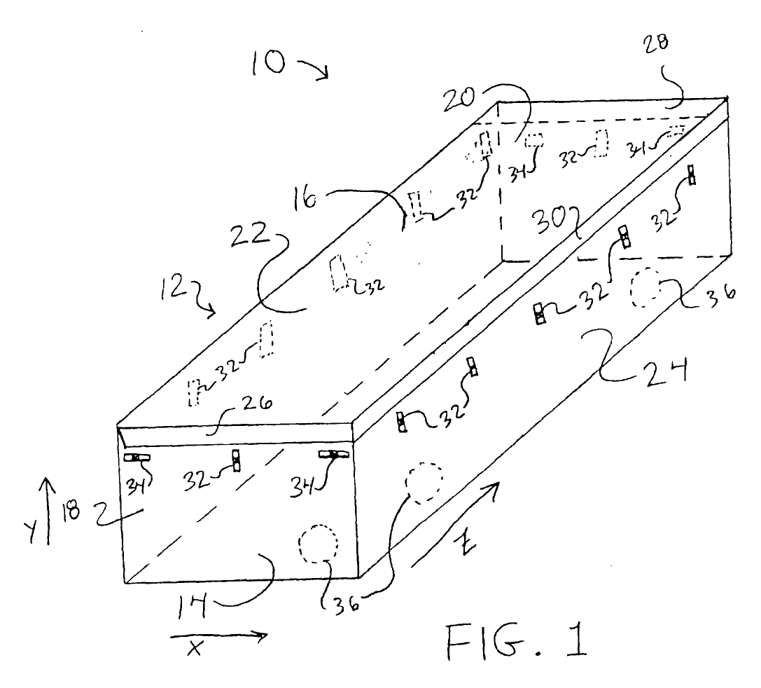

Referring now to FIG. 1, an exemplary isolation chamber 10 provides containment for a contaminated patient (not shown) received therein and is configured to be used with a stretcher with railings, such as a hospital-type stretcher (not shown). The isolation chamber 10 includes a flexible enclosure 12. The enclosure 12 is suitably made from a flexible material that may be rolled up or folded into a compact shape for storage, such as in a storage container or a bag, unrolled or unfolded into a desired shape for use, and that retains its shape while in use. Given by way of non-limiting example, the enclosure 12 may be made out of polyvinyl chloride (PVC). For example, without limitation the PVC may have a thickness in a range of around 16/1000 inch (mil) to around 30 mil. However, it will be appreciated that any thickness of material for the enclosure 12 may be selected as desired for a particular application. Further, the enclosure 12 may be made from material that can be seen through, such as clear PVC or colored PVC. Advantageously, this permits a contaminated patient in the isolation chamber 10 to see outside the isolation chamber 10 and permits the contaminated patient to be seen by EMS personnel, other medical care providers, and other people outside the isolation chamber 10.

The enclosure 12 includes a bottom 14 (shown in phantom), a top 16, a first end 18, a second end 20 (shown in phantom), a first side 22 (shown in phantom), and a second side 24. It will be appreciated that the enclosure 12 is shown in a shape ready for use instead of configured for storage. The discussion herein is directed toward the shape ready for use. In one present embodiment, the bottom 14 and the top 16 are substantially rectangular and have substantially the same dimensions as each other. Similarly, the first and second ends 18 and 20 are substantially rectangular and have substantially the same dimensions as each other. Likewise, the first and second sides 22 and 24 are substantially rectangular and have substantially the same dimensions as each other. The bottom 14, top 16, first and second ends 18 and 20, and first and second sides 22 and 24 are sized such that the enclosure 12 suitably defines a volume that is sized to receive an average-sized person therein. For example, exemplary dimensions given by way of non-limiting example include a height of around 11 inches along a y direction, a width of around 26 inches along an x direction, and a length of around 78 inches along a z direction. It will be appreciated that any dimension in any direction may be selected as desired for a particular application.

The top 16 defines a first flap 26 adjacent and overhanging the first end 18, a second flap 28 (shown in phantom) adjacent and overhanging the second end 20, and a third flap 30 adjacent and overhanging the second side 24. The flaps 26, 28, and 30 and the first and second ends 18 and 20 and the second side 24 are advantageously provided with closures (not shown) that releasably attach the top 16 to the first and second ends 18 and 20 and to the second side 24. The flaps 26, 28, and 30 and the closures thereby cooperate to provide a means for maintaining the top 16 spaced apart from the bottom 14 and out of physical contact with a contaminated patient received in the enclosure 12. The closures may include any acceptable type of closure, such as without limitation hook-and-loop closures, zippers, snaps, and the like.

Except for the releasable attachment of the top 16 to the first and second ends 18 and 20 and to the second side 24 as discussed above, the bottom 14, the top 16, the first and second ends 18 and 20, and the first and second sides 22 and 24 are suitably attached to adjacent components of the enclosure 12 by any acceptable attachment method. Non-limiting examples of acceptable attachment methods include stitching or other bonding methods, such as welding techniques like dielectric or radio frequency (RF) welding. A plurality of loops 32 are provided on exterior surfaces of the first and second ends 18 and the first and second sides 22 and 24. The loops advantageously permit the isolation chamber 10 to be attached to rails disposed on a stretcher (not shown). The loops 32 are suitably made of any acceptable material and are attached to the first and second ends 18 and 20 and to the first and second sides 22 and 24 in any acceptable manner. In one exemplary embodiment, the loops 32 are made from hook-and-loop fastener material to permit fast, easy, and secure attachment of the isolation chamber 10 to a stretcher.

If desired, a plurality of corner loops 34 may be provided on exterior surfaces of the first and second ends 18 and 20 outboard of the loops 32 and located toward corners of the first and second ends 18 and 20. The corner loops 34 advantageously align with vertical posts (not shown) provided on some stretchers and receive the vertical posts therein. This provides additional stability when the stretcher includes vertical posts, or provides a primary means for stabilizing the isolation chamber 10 on a stretcher without rails (thereby rendering the loops 32 unused).

If desired, a plurality of ports 36 are suitably provided within the enclosure 12. The ports 36 advantageously provide EMS personnel and other medical care providers an ability to access the contaminated patient and to connect desired devices to the contaminated patient without detaching the top 16. For example, the ports 36 may permit oxygen tubes, intravenous tubes, and wires for monitoring devices such as an electrocardiogram or devices for monitoring other vital signs to be connected to the contaminated patient. The ports 36 are suitably defined by any acceptable method, such as a weld path. To create an opening at a desired location, the selected port 36 is removed, such as by poking or cutting. Alternately, the connections to the contaminated patient may be provided by running the desired connection between the top 16 and the first or second end 18 or 20 or the second side 24, as desired. In such a case, the closure is closed around the connection to maintain the top 16 closed.

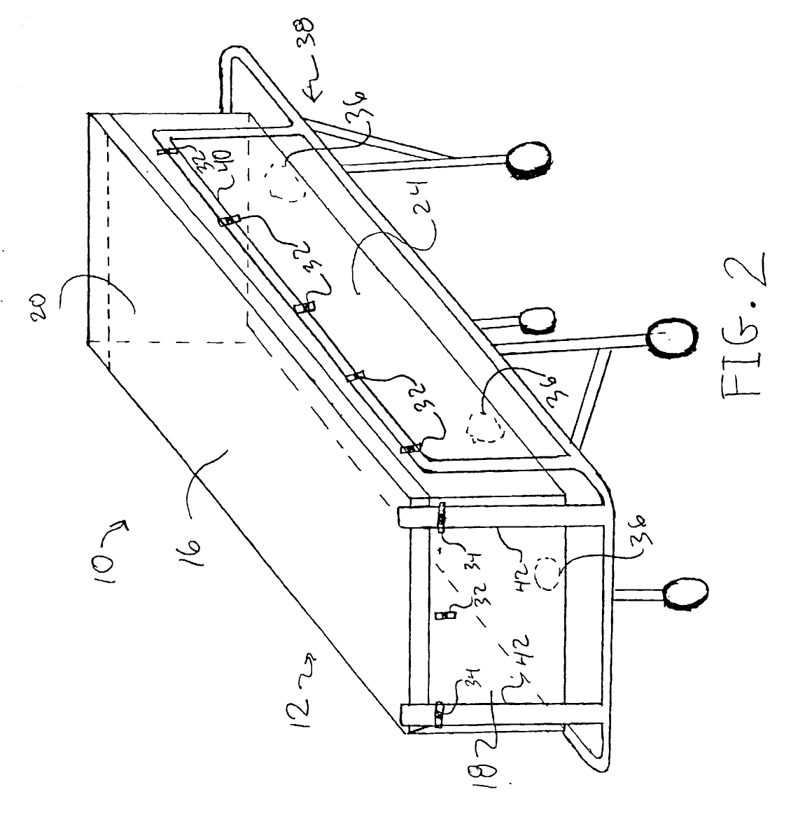

Referring now to FIGS. 1 and 2, operation of the isolation chamber 10 will be explained. The isolation chamber 10 is removed from storage and is laid out on a stretcher 38, such as without limitation a hospital-type stretcher. The loops 32 are closed around the rails 40 of the stretcher 38. Alternately, or in addition, the corner loops 34 are closed around posts 42 of the stretcher, if desired. The closures are opened, thereby permitting the top 16 to be opened. With the top 16 opened, the enclosure 12 is shaped for use. The contaminated patient is placed in the isolation chamber 10. The closures are closed to attach the top 16 to the first and second ends 18 and 20 and to the second side 24. The closure is closed around any connections, such as an intravenous connection or an oxygen tube or wires for monitoring devices, to the contaminated patient. The ports 36 are opened as desired. After treatment, the contaminated patient is removed from the isolation chamber 10 and the isolation chamber 10 may be disposed of or sanitized using known methods for further use, as desired.

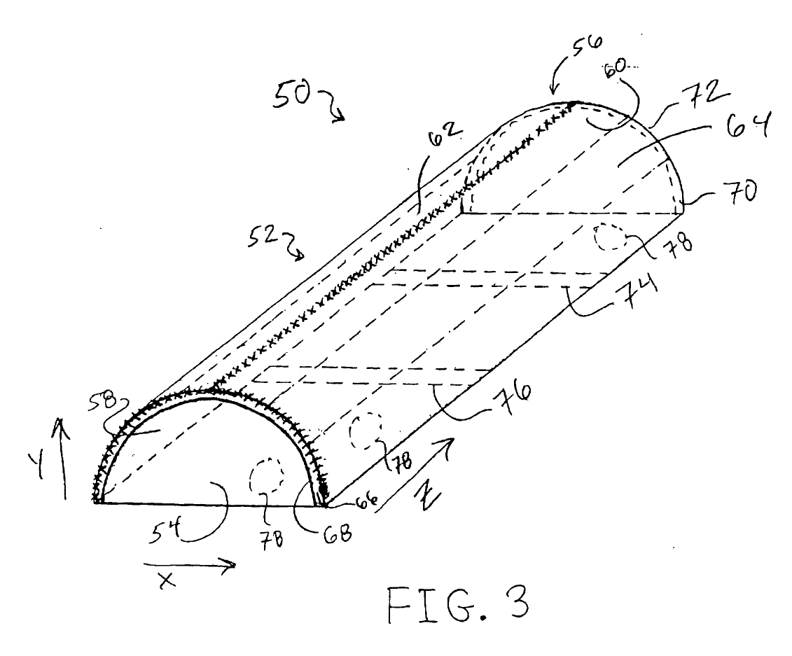

Referring now to FIG. 3, an alternate embodiment of an isolation chamber 50 provides containment for a contaminated patient (not shown) received therein and is configured to be used with a rail-less stretcher, such as a field-type stretcher (not shown). The isolation chamber 50 shares many components in common with the isolation chamber 10 (FIG. 1). As a result, repetition of details of common components is not necessary for an understanding of the isolation chamber 50. The isolation chamber 50 includes a flexible enclosure 52. The enclosure 12 is suitably made from the same material as the enclosure 12 (FIG. 1).

The enclosure 52 includes a bottom 54 (shown in phantom), a top 56, a first end 58, and a second end 60 (shown in phantom). The top includes a first section 62 and a second section 64. In one present embodiment, the bottom 14 is substantially rectangular. The first and second sections 62 and 64 are also are substantially rectangular and have substantially the same dimensions as each other. The first end section 62 is hingedly pivotable about a first side of the bottom 54, and the second section 64 is hingedly pivotable about a second side of the bottom 54. The first and second ends 58 and 60 are substantially semi-circular and have substantially the same dimensions as each other. The bottom 54, top 56, and first and second ends 58 and 60 are sized such that the enclosure 52 suitably defines a volume along x, y, and z directions similar to that of the enclosure 10 (FIG. 1).

The first end 58 defines a first pocket 66 about a periphery of the first end 58. A first support member, such as a first rod 68, conforms to a shape of the periphery of the first end 58. The rod 68 may be made of any material as desired, such as nylon, aluminum, steel, or the like. Given by way of non-limiting example, the periphery of the first end 58, the first pocket 66, and the first rod 68 are substantially semi-circular. The first rod 68 is inserted in the first pocket 66 to enable the first end 58 to retain its desired shape for use. If desired, the second end 60 may define a second pocket 70 about a periphery of the second end 60. In this case, a second support member, such as a second rod 72 that is similar to the first rod 68, conforms to a shape of the periphery of the second end 60. The second rod 72 is inserted in the second pocket 70 to enable the second end 60 to retain its desired shape for use.

Closures are provided along edges where the first and second sections 62 and 64 intersect to releasably attach the first and second sections 62 and 64 to each other. Closures may also be provided, if desired, along the peripheries of the fist and second ends 58 and 60 and the first and second sections 62 and 64 where the first and second sections 62 and 64 intersect the first and second ends 58 and 60. This permits the first and second sections 62 and 64 to be releasably attached to the first and second ends 58 and 60. The pockets 66 and 70, rods 68 and 72, and closures thereby provide a means for maintaining the top 56 spaced apart from the bottom 54 and out of physical contact with a contaminated patient received in the enclosure 52. The closures may include any acceptable type of closure, such as without limitation hook-and-loop closures, zippers, snaps, and the like. Except for the releasable attachment of the first and second sections 62 and 64 to each other and to the first and second ends 58 and 60 as discussed above, the bottom 54, the top 56, and the first and second ends 58 and 60 are suitably attached to adjacent components of the enclosure 52 as discussed above for the enclosure 12 (FIG. 1).

Advantageously, at least first webbing, such as polypropylene webbing 74 (shown in phantom), transverses the bottom 54 between first and second sides of the bottom 54. The webbing 74 is suitably provided interior or exterior the enclosure 52. However, the webbing 74 is preferably provided exterior the enclosure 52 in order to minimize materials potentially contaminated by a contaminated patient received in the isolation chamber 50. The webbing 74 advantageously provides support for weight of the contaminated patient received in the isolation chamber 50. Accordingly, the webbing 74 is suitably located along the bottom 54 to provide support in an approximate location of buttocks of the contaminated patient. However, it will be appreciated that the webbing 74 may be located as desired. Additionally, if desired, second webbing 76 that is similar to the first webbing 74 may provide additional support for weight of the contaminated patient. The second webbing 76 may be located as desired, such as without limitation in an approximate location of the back of the contaminated patient.

Finally, a plurality of ports 78, similar to the plurality of ports 36 (FIG. 1), may be provided as desired.

The isolation chamber 50 operates as follows. The enclosure 52 is removed from storage and is laid out on a suitable surface. The closures are opened, thereby permitting the top 56 to be opened. With the top 56 opened, the enclosure 52 is shaped for use. The first rod 68 is inserted in the first pocket 66. If desired, the second rod 72 is inserted in the second pocket 70. The contaminated patient is placed in the isolation chamber 50, and the isolation chamber 50 is lifted onto a rail-less stretcher, such as a field stretcher (not shown). The closures are closed to attach the first and second sections 62 and 64 to each other and to the first and second ends 58 and 60. The closures are closed around any connectors, such as an intravenous connector or an oxygen tube or wires for monitoring devices, to the contaminated patient. The ports 78 are opened as desired. After treatment, the contaminated patient is removed from the isolation chamber 50 and the isolation chamber 50 may be disposed of or sanitized using known methods for further use, as desired.

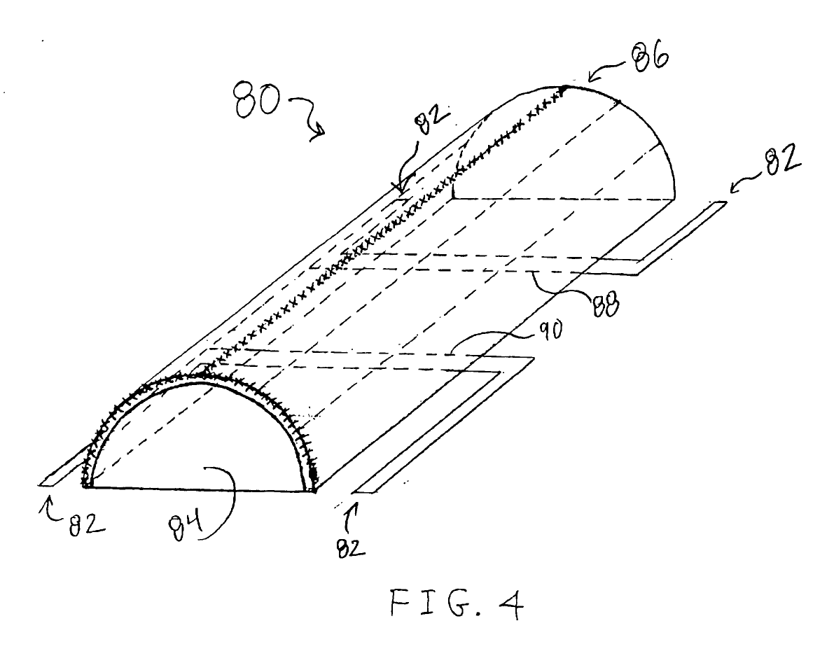

Referring now to FIG. 4, an isolation chamber 80 is a variant of the isolation chamber 50 (FIG. 3) that advantageously also functions as a field stretcher. In addition to features of the isolation chamber 50 (FIG. 3) already described herein, the isolation chamber 80 includes handles 82 that are provided toward first and second ends 84 and 86. If desired, the handles may extend from first and second webbing 88 and 90. Alternately, the handles 82 may be provided as hand-holds disposed at the first and second ends 84 and 86 or as any acceptable hand-hold known in the art. The isolation chamber 80 operates similar to the isolation chamber 50 (FIG. 3), except it is not necessary to lift the isolation chamber 80 onto a rail-less stretcher, such as a field stretcher. This is because the isolation chamber 80 may be lifted and carried by the handles 82, thereby functioning as its own field stretcher.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. An isolation chamber for providing containment of a contaminated patient, the isolation chamber comprising:
a flexible enclosure configurable to receive a contaminated patient therein, the enclosure including a bottom, a top, a first end, and a second end; and
means for maintaining the top spaced apart from the bottom such that the top is maintained out of physical contact with a contaminated patient received in the enclosure.

2. The isolation chamber of claim 1, further comprising:
first and second sides disposed between the first and second ends and between the top and bottom, the top being hingedly pivotable about a top of the first side; and
wherein the maintaining means includes a plurality of closures disposed on the first end, the second end, the second side, and the top, the plurality of closures being configured to releasably attach the top to the first and second ends and to the second side.

3. The isolation chamber of claim 2, further comprising means for attaching the first and second sides to rails disposed on a stretcher.

4. The isolation chamber of claim 1, wherein:
the first end defines a pocket that extends about a periphery of the first end; and
the maintaining means includes a rod that conforms to a shape of the periphery of the first end, the rod being receivable in the pocket.

5. The isolation chamber of claim 4, further comprising at least first webbing that transverses the bottom between the first and second sides.

6. The isolation chamber of claim 5, further comprising handles disposed toward the first and second ends.

7. An isolation chamber for providing containment of a contaminated patient, the isolation chamber comprising:
a flexible enclosure configurable to receive a contaminated patient therein, the enclosure including a first side, a second side, a top that is hingedly pivotable about a top of the first side, a bottom, a first end, and a second end;
means for maintaining the top spaced apart from the bottom such that the top is maintained out of physical contact with a contaminated patient received in the enclosure; and
a plurality of attachment devices disposed on at least one of the first and second sides or the first and second ends, the plurality of attachment devices being configured to attach one of the first and second sides or the first and second ends to support members of a stretcher.

8. The isolation chamber of claim 7 wherein the maintaining means includes a plurality of closures disposed on the first end, the second end, the second side, and the top, the plurality of closures being configured to releasably attach the top to the first and second ends and the second side.

9. The isolation chamber of claim 8, wherein the closures includes hook and loop closures.

10. The isolation chamber of claim 8, wherein the closures include zippers.

11. The isolation chamber of claim 8, wherein the closures include snaps.

12. The isolation chamber of claim 7, wherein at least one of the first or second sides or at least one of the first or second ends defines at least one port therein.

13. The isolation chamber of claim 12, wherein the at least one port is defined by a substantially circular weld path.

14. An isolation chamber for providing containment of a contaminated patient, the isolation chamber comprising:
a flexible enclosure configurable to receive a contaminated patient therein, the enclosure including a first end defining a first pocket that extends about a periphery of the first end, a second end, a bottom, and a top, the top having a first section that is hingedly pivotable about a first side of the bottom, the top having a second section that is hingedly pivotable about a second side of the bottom;
a first rod that conforms to a shape of the periphery of the first end, the first rod being receivable in the first pocket;
at least one closure disposed on the first and second sections of the top, the at least one closure being configured to releasably attach the first section of the top to the second section of the top; and
at least first webbing that transverses the bottom between the first and second sides of the bottom.

15. The isolation chamber of claim 14, wherein the at least one closure includes a hook and loop closure.

16. The isolation chamber of claim 14, wherein the at least one closure includes a zipper.

17. The isolation chamber of claim 14, wherein the second end defines a second pocket that extends about a periphery of the second end, the isolation chamber further comprising a second rod that conforms to a shape of the periphery of the second end, the second rod being receivable in the second pocket.

18. The isolation chamber of claim 14, further comprising second webbing that transverses the bottom between the first and second sides of the bottom, the second webbing being spaced apart from the first webbing.

19. An isolation chamber for providing containment of a contaminated patient, the isolation chamber comprising:
a flexible enclosure configurable to receive a contaminated patient therein, the enclosure including a first end defining a first pocket that extends about a periphery of the first end, a second end, a bottom, and a top, the top having a first section that is hingedly pivotable about a first side of the bottom, the top having a second section that is hingedly pivotable about a second side of the bottom;
a first rod that conforms to a shape of the periphery of the first end, the first rod being receivable in the first pocket;
at least one closure disposed on the first and second sections of the top, the at least one closure being configured to releasably attach the first section of the top to the second section of the top;
at least first webbing that transverses the bottom between the first and second sides of the bottom; and
handles disposed toward the first and second ends.

20. The isolation chamber of claim 19, wherein the at least one closure includes a hook and loop closure.

21. The isolation chamber of claim 19, wherein the at least one closure includes a zipper.

22. The isolation chamber of claim 19, wherein the second end defines a second pocket that extends about a periphery of the second end, the isolation chamber further comprising a second rod that conforms to a shape of the periphery of the second end, the second rod being receivable in the second pocket.

23. The isolation chamber of claim 19, further comprising second webbing that transverses the bottom between the first and second sides of the bottom, the second webbing being spaced apart from the first webbing.
